(19) United States
(12) Patent Application Publication
(10) Pub. No.: US 2016/0155263 A1
(43) Pub. Date: Jun. 2, 2016

(54) METHOD AND DEVICE FOR SELECTING ARTICLES CORRESPONDING TO THE DIMENSIONS OF A USER

(71) Applicant: Artashes Valeryevich IKONOMOV, Moscow (RU)

(72) Inventor: Artashes Valeryevich IKONOMOV, Moscow (RU)

(21) Appl. No.: 14/901,962

(22) PCT Filed: Nov. 17, 2014
(86) PCT No.: PCT/RU2014/000873

§ 371 Date: Dec. 29, 2015

(30) Foreign Application Priority Data
Jun. 16, 2014 (RU) 2014124235

(51) Int. Cl. G06T 17/00; G06T 19/20; G06F 17/30

(52) U.S. Cl. CPC G06T 17/00; G06F 17/30867; G06F 17/30256; G06T 19/20; G06T 2219/2004

(57) ABSTRACT

A device for selecting articles corresponding to the user dimensions includes a module for construction of a three-dimensional anthropological user model, a module for construction of a three-dimensional articles model, a server for connecting users client devices and including (i) a module for inputting data with the user dimensions, (ii) a database of articles with the articles dimensions, (iii) a module for comparing the user dimensions with the articles dimensions, the module including a unit for juxtaposing the three-dimensional anthropological user model and the three-dimensional articles model, (iv) a module for displaying articles corresponding to the user, said modules being connected with each other. The unit for juxtaposing includes a unit for dynamically juxtaposing the anthropological user model and the articles model.

### TECHNICAL FIELD OF INVENTION

The invention relates to the field of data processing, and specifically, to devices for selecting articles corresponding to the dimensions of a user which include a server adapted for connection, by means of a unified network, with users client devices, said server comprising a module for inputting data with user dimensions from said client devices, a database of articles with the dimensions of said articles, a module for comparing the dimensions of the user with the dimensions of the articles in the database, a module for displaying articles corresponding to the dimensions of the user, said modules being connected with each other; said invention may be employed by the users of client devices, having Internet network connection, for remote selecting of articles in accordance with the required dimensions, for example, of clothing.

Following terms are adopted in the description and the claims:
a three-dimensional anthropological model of the user is a three-dimensional reconstruction of the user's shape and image taking into consideration his real dimensions, which allows to simulate a juxtaposition of the real-dimensioned user with other objects or positioning inside the same.
a three-dimensional model of the articles is a three-dimensional reconstruction of the articles shape taking into consideration their real dimensions and some properties of their constituent materials, for example, a type of fabric for clothing.

### PRIOR ART

A known example of prior art is a device for selecting articles corresponding to the dimensions of a user which includes a server adapted for connection, by means of a unified network, with users client devices, said server comprising a module for inputting data with user dimensions from said client devices, a database of articles with the dimensions of said articles, a module for comparing the dimensions of the user with the dimensions of the articles in the database, a module for displaying articles corresponding to the dimensions of the user, said modules being connected with each other, said device additionally comprises a module for construction of a three-dimensional anthropological model of the user, connected with the module for inputting data with user dimensions from said client devices and the module for comparing the dimensions of the user with the dimensions of the articles in the database, said device additionally comprises a module for construction of a three-dimensional model of the articles, said module being connected to the database and the module for comparing the dimensions of the user with the dimensions of the articles in the database, the module for comparing the dimensions of the user with the dimensions of the articles in the database comprises a unit for juxtaposing the three-dimensional anthropological model of the user and the three-dimensional model of the articles. (See Patent for the invention RU 2504009 C1 published at Jan. 10, 2014).

This device is the closest to the essence of the claimed invention and is considered here as a prototype of the claimed invention.

The drawback of said device is an insufficient accuracy of articles selection in accordance with the dimensions of a user by means of an option to juxtapose the three-dimensional anthropological model of the user and the three-dimensional model of the articles taking into consideration a possible movement of the anthropological model of the user. Therefore, it is impossible to take into consideration the user's anthropological parameters in dynamics and to select him an article of a relevant size with all due accuracy to suit both a static user shape and a user body shape in different positions and in motion.

### DISCLOSURE OF THE INVENTION

The present invention relies on this novel observation with the primary aim to offer a device for selecting articles corresponding to the dimensions of a user that serves at least to mitigate one of the aforementioned drawbacks, namely, to provide increased accuracy of articles selection in accordance with the dimensions of the user by means of an option to juxtapose the three-dimensional anthropological model of the user and the three-dimensional model of the articles taking into consideration a possible movement of the anthropological model of the user.

To achieve this goal, the unit for juxtaposing the three-dimensional anthropological model of the user and the three-dimensional model of the articles comprises a unit for dynamic juxtaposing the three-dimensional anthropological user model and the three-dimensional model of the articles adapted to take into consideration movements of the user in conjunction with an article of interest.

This useful feature makes it possible to juxtapose the three-dimensional user and article models not only in statics but also in dynamics to take into consideration movements of the user in conjunction with an article of interest. A typical example is trying on clothes or shoes wherein a user typically performs some movements or makes several steps to check if the article fits his/her size when it is on, to ensure that clothes are not too tight when sitting down, bending or twisting. For armchairs, sofas and other furniture, the user can check if it is comfortable for different body positions.

There is an embodiment of the invention in that the module for displaying articles corresponding to the dimensions of the user comprises a unit for three-dimensional visualizing the selected article together with the user.

This useful feature makes it possible to demonstrate the selection result so that the user could make a more informed buying decision. This solution simulates a showroom mirror where the user can see his/her reflection.

There is an embodiment of the invention in that the module for inputting data with user dimensions from the client devices includes a unit for decoding an information encoded in bar-graphic form on the client device of the user.

This useful feature makes it possible to transfer to the server the barcoded, OR-coded or similarly encoded information on dimensions of the user. The purpose of this solution is to protect personal data of the user dimensions from a third-party access. Indeed, not all users agree to make such data public.

It should be noted that the client device of the user, for example, a smartphone cell phone or a computer with a camera, for example, a laptop or a tablet PC can automatically map such barcode, OR code or other code with the user dimensions. This can be achieved by taking pictures of the user in different projections (for example, a lateral view, a frontal view, standing or partially—if shoes are concerned, then a photo of one or two user feets are taken), mapping this image to absolute coordinates (scaling) and outputting further data related to the detailed anthropological dimensions of the user in an encoded form.

The combination of the essential features of the claimed invention is unknown from the prior art, therefore it is possible to conclude that the invention satisfies the novelty criterion.

### BRIEF DESCRIPTION OF DRAWINGS

Other distinguishing features and advantages of the invention are readily apparent from the description below, which includes but is not limited to the following features, with reference to the figures attached:

FIG. 1 represents schematically a functional diagram of a device for selecting articles corresponding to the dimensions of a user in accordance with the invention.

FIG. 2 demonstrates functional stages of the device according for selecting articles corresponding to the dimensions of a user in accordance with the invention.

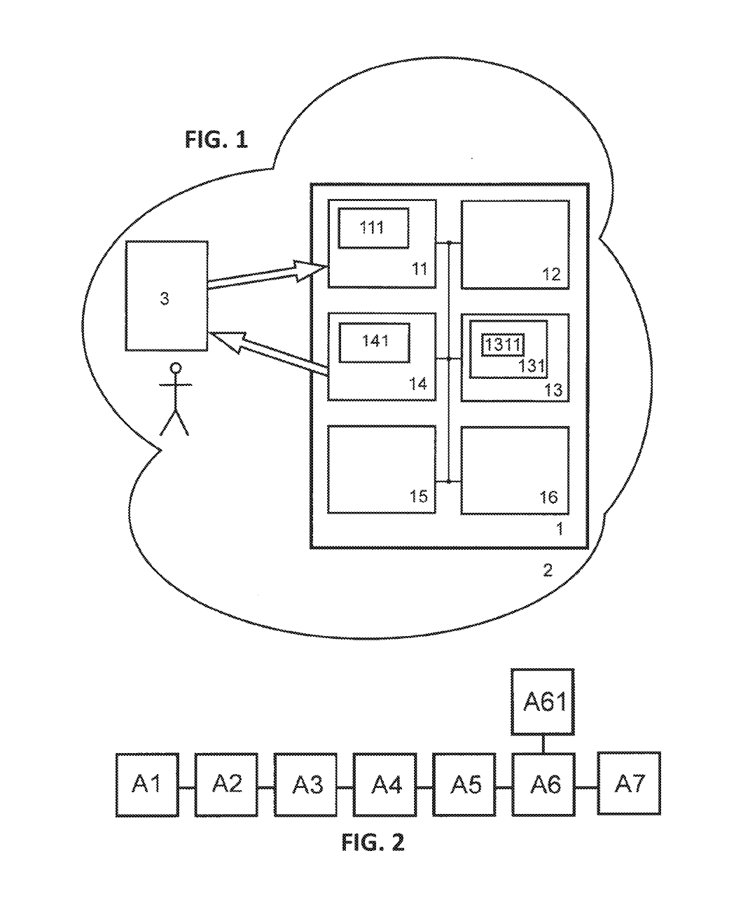

According to the FIG. 1, a device for selecting articles corresponding to the dimensions of a user includes a server 1 adapted for connection, by means of a unified network 2, with users client devices 3. The server 1 comprises a module 11 for inputting data with user dimensions from said client devices, a database 12 of articles with the dimensions of said articles, a module 13 for comparing the dimensions of the user with the dimensions of the articles in the database, a module 14 for displaying articles corresponding to the dimensions of the user, said modules being connected with each other.

The device additionally comprises a module 15 for construction of a to three-dimensional anthropological model of the user, connected with the module 11 for inputting data with user dimensions from said client devices and the module 13 for comparing the dimensions of the user with the dimensions of the articles in the database 12.

The device additionally comprises a module 16 for construction of a three-dimensional model of the articles, said module being connected to the database 12 and the module 13 for comparing the dimensions of the user with the dimensions of the articles in the database 12.

The module 13 for comparing the dimensions of the user with the dimensions of the articles in the database comprises a unit 131 for juxtaposing the three-dimensional anthropological model of the user and the three-dimensional model of the articles.

The unit 131 for juxtaposing the three-dimensional anthropological model of the user and the three-dimensional model of the articles comprises a unit 1311 for dynamic juxtaposing the three-dimensional anthropological model of the user and the three-dimensional model of the articles.

The module 14 for displaying articles corresponding to the dimensions of the user comprises a unit 141 for three-dimensional visualizing the selected article together with the user.

The module 11 for inputting data with user dimensions from the client devices includes a unit 111 for decoding an information encoded in bar-graphic form on the client device 3 of the user.

In general, any variety of computing platforms that can be connected to a network such as the unified network 2 and can interact with applications can be a client device 3, which is not included in the invention. Typical examples of such independent client devices include but are not limited to desktop and laptop personal computers, smart cellular phones (smartphones), lightweight clients, workstations, “non-intelligent” terminals connected to a to server with applications and various combinations and configurations of the same, i.e. these include both physical devices that ensure interaction as part of communication and virtual devices based on programmable computers and having program interface to enable such communication.

The unified network 2 as well as all connections between all modules and units include a multitude of topologies, configurations and arrangements of the internetworking components built so as to connect corporate, global and local computer networks. Such network includes but is not limited to traditional wired and wireless, satellite, optical and equivalent networking technology.

### IMPLEMENTATION OF THE INVENTION

The device for selecting articles corresponding to the dimensions of a user functions as follows. (A non-limiting example of the implementation of the invention is provided).

Preliminary, anthropological dimensions of a user are automatically determined by means of, for example, a user client device such as a smart cell phone or a computer equipped with a camera, e.g. a laptop or a tablet PC. This can be achieved by taking pictures of the user in different projections, mapping this image to absolute coordinates and outputting further data related to the detailed anthropological dimensions of the user in an encoded form such as a barcode, OR code or other code with the user dimensions. Conventionally, this can be called as a “passport of the user dimensions”.

According to the FIG. 2:

Stage A1. Users are connected to the server 1 through a unified network 2 by means of their client devices 3.

Stage A2. A user transfers his/her encoded anthropological data to the server 1 by means of his/her client device 3.

Stage A3. The module 11 for inputting data with user dimensions from the client devices decodes the encoded data obtained on the Stage A2 by means of the unit 111 for decoding the graphically encoded information on the client device 3.

Stage A4. The user initiates a search query concerning relevant articles and dimensions that must correspond to the user dimensions by means of the client device 3.

Stage A5. The device constructs a three-dimensional model of the articles by means of the module 16 for construction of a three-dimensional model of the articles.

Stage A6. The module 13 for comparing the dimensions of the user with the dimensions of the articles in the database 12 realizes a juxtaposition of the said models in statics by means of the unit 131 for juxtaposing the three-dimensional anthropological model of the user and the three-dimensional model of the articles.

Stage A61. If required, the unit 131 for juxtaposing the three-dimensional anthropological model of the user and the three-dimensional model of the articles realizes a juxtaposition of the said models taking into consideration the dynamics of movements of the user by means of the unit 1311 for dynamic juxtaposing the three-dimensional anthropological model of the user and the three-dimensional model of the articles. This method helps to answer the question, if the compatibility criteria are not applicable for possible movements of the user. For example—in the case of buying shoes—if the selected shoes are too tight for walking.

Stage A7. Once the articles corresponding to the user in view of his/her dimensions are selected, the module 14 for displaying articles corresponding to the dimensions of the user sends an image of the article together with the user to the client device 3 of the user by means of the unit 141 for three-dimensional visualizing the selected article together with the user. This can be perspective views or a three-dimensional image adapted for turning and zooming by means of the client device. Generally, if the client device of the user permits displaying the three-dimensional image, thus, it is possible—during this Stage—to display to the user the three-dimensional image to adapted to be seen in special glasses (stereo vision) or as a holographic image.

An illustrative example of the embodiment of this invention is selection of clothes. It is a general knowledge that any item of clothing must be tried on, the data related to height and chest circumference (volume) are insufficient. is However, a construction of the three-dimensional anthropological model of the user makes it possible to take into consideration many parameters of the user such as a distance between preselected reference points on the external surface of the user body shape. The more dimensions are included in such model, the more accurate is the selection. Similarly, when a three-dimensional model of the article is constructed it is possible to take into consideration not only physical parameters but also those parameters that may be helpful for checking the behavior of the article in a dynamic state, namely: elasticity, ductility, softness, etc.

Said embodiments of the invention are given herein by way of example and allow for new options or modifications for any eligible application.

### INDUSTRIAL APPLICABILITY

The claimed device for selecting articles corresponding to the dimensions of a user may be implemented in practice by one skilled in the art and ensures that the claimed objectives are met after implementation. The opportunity for practical embodiment of the invention by one skilled in the art results from the fact that for each attribute included in the claim as based on the description, an equivalent material embodiment is known, which leads to the conclusion that the invention meets the requirement of “industrial applicability”.

According to the claimed invention, the applicants made a device for selecting articles corresponding to the dimensions of a user.

Trial runs of the device for selecting articles corresponding to the dimensions of a user demonstrated that it enables the following:
input of data comprising an information on user dimensions encoded in bar-graphic form from the client devices,
construction of a three-dimensional anthropological model of the user according to the inputted data,
construction of a three-dimensional model of the articles according to existing data about articles,
carry out a juxtaposition of the three-dimensional anthropological model of the user and the three-dimensional model of the articles in static mode,
carry out a juxtaposition of the three-dimensional anthropological model of the user and the three-dimensional model of the articles in dynamic mode, i.e. taking into consideration possible movements of the user,
display the relevant search results aiming the articles of suitable dimensions on the client device of the user.

All of the above ultimately serves to achieve the stated technical result, i.e. increased accuracy of selection of articles in accordance with the dimensions of a user by means of an option to juxtapose the three-dimensional anthropological model of the user and the three-dimensional model of the articles taking into consideration a possible movement of the anthropological model of the user.

1. A device for selecting articles corresponding to the dimensions of a user which includes:
a server adapted for connection, by means of a unified network, with users client devices, said server comprising:
a module for inputting data with user dimensions from said client devices,
a database of articles with the dimensions of said articles,
a module for comparing the dimensions of the user with the dimensions of the articles in the database, and
a module for displaying articles corresponding to the dimensions of the user, said modules being connected with each other,
said device additionally comprising:
a module for construction of a three-dimensional anthropological model of the user, said module being connected with the module for inputting data with user dimensions from said client devices and the module for comparing the dimensions of the user with the dimensions of the articles in the database, and
a module for construction of a three-dimensional model of the articles, said module being connected to the database and the module for comparing the dimensions of the user with the dimensions of the articles in the database, said module for comparing the dimensions of the user with the dimensions of the articles in the database comprises a unit for juxtaposing the three-dimensional anthropological model of the user and the three-dimensional model of the articles,
wherein the unit for juxtaposing the three-dimensional anthropological model of the user and the three-dimensional model of the articles comprises a unit for dynamic juxtaposing the three-dimensional anthropological user model and the three-dimensional model of the articles adapted to take into consideration movements of the user in conjunction with an article of interest.

2. The device for selecting articles corresponding to the dimensions of a user according to claim 1, wherein the module for displaying articles corresponding to the dimensions of the user comprises a unit for three-dimensional visualizing the selected article together with the user.

3. The device for selecting articles corresponding to the dimensions of a user according to claim 1, wherein the module for inputting data with user dimensions from the client devices includes a unit for decoding an information encoded in bar-graphic form on the client device of the user.

4. A method for selecting articles corresponding to the dimensions of a user including:
connecting a server, by means of a unified network, to users client devices,
inputting data with user dimensions from said client devices,
forming a database of articles with the dimensions of said articles,
constructing a three-dimensional anthropological model of the user,
constructing a three-dimensional model of the articles,
comparing the dimensions of the user with the dimensions of the articles in the database,
juxtaposing the three-dimensional anthropological model of the user with the three-dimensional model of the articles,
transmitting, to the client device of the user, data regarding articles corresponding to the dimensions of the user,
wherein a dynamic juxtaposition is additionally carried out between the three-dimensional anthropological model of the user and the three-dimensional model of the articles, which takes into consideration movements of the user in conjunction with an article of interest.

5. The method for selecting articles according to claim 4, wherein a three-dimensional visualization of the selected article together with the user is additionally carried out.

6. The method for selecting articles according to claim 4, wherein decoding of an information encoded in bar-graphic form on the client device of the user is additionally carried out.

7. The method for selecting articles according to claim 5, wherein decoding of an information encoded in bar-graphic form on the client device of the user is additionally carried out.

8. The device for selecting articles corresponding to the dimensions of a user according to claim 2, wherein the module for inputting data with user dimensions from the client devices includes a unit for decoding an information encoded in bar-graphic form on the client device of the user.

9. The device for selecting articles corresponding to the dimensions of a user according to claim 2, wherein the three-dimensional image of the article together with the user generated by the unit for three-dimensional visualizing the selected article together with the user and displayed on the client device of the user by the module for displaying articles corresponding to the dimensions of the user, is adapted for turning and zooming by means of the client device.

10. The device for selecting articles corresponding to the dimensions of a user according to claim 8, wherein the three-dimensional image of the article together with the user generated by the unit for three-dimensional visualizing the selected article together with the user and displayed on the client device of the user by the module for displaying articles corresponding to the dimensions of the user, is adapted for turning and zooming by means of the client device.

11. The device for selecting articles corresponding to the dimensions of a user according to claim 9, wherein the client device is adapted to display three-dimensional images, and wherein the three-dimensional image of the article together with the user generated by the unit for three-dimensional visualizing the selected article together with the user and displayed on the client device of the user by the module for displaying articles corresponding to the dimensions of the user, contains one of following images: (a) holographic image; (b) stereo image adapted to be seen in stereo vision glasses.

12. The device for selecting articles corresponding to the dimensions of a user according to claim 10, wherein the client device is adapted to display three-dimensional images, and wherein the three-dimensional image of the article together with the user generated by the unit for three-dimensional visualizing the selected article together with the user and displayed on the client device of the user by the module for displaying articles corresponding to the dimensions of the user, contains one of following images: (a) holographic image; (b) stereo image adapted to be seen in stereo vision glasses.

13. The device for selecting articles corresponding to the dimensions of a user according to claim 1, wherein the module for construction of a three-dimensional model of the articles is adapted to take into consideration parameters determining a behavior of the article in a dynamic state.

14. The device for selecting articles corresponding to the dimensions of a user according to claim 2, wherein the module for construction of a three-dimensional model of the articles is adapted to take into consideration parameters determining a behavior of the article in a dynamic state.

15. The device for selecting articles corresponding to the dimensions of a user according to claim 3, wherein the module for construction of a three-dimensional model of the articles is adapted to take into consideration parameters determining a behavior of the article in a dynamic state.

16. The device for selecting articles corresponding to the dimensions of a user according to claim 8, wherein the module for construction of a three-dimensional model of the articles is adapted to take into consideration parameters determining a behavior of the article in a dynamic state.

17. The device for selecting articles corresponding to the dimensions of a user according to claim 9, wherein the module for construction of a three-dimensional model of the articles is adapted to take into consideration parameters determining a behavior of the article in a dynamic state.

18. The device for selecting articles corresponding to the dimensions of a user according to claim 12, wherein the module for construction of a three-dimensional model of the articles is adapted to take into consideration parameters determining a behavior of the article in a dynamic state.

19. The device for selecting articles corresponding to the dimensions of a user according to claim 1, wherein the module for construction of a three-dimensional anthropological model of the user is adapted to take into consideration a distance between preselected reference points on the external surface of the user body shape.

20. The device for selecting articles corresponding to the dimensions of a user according to claim 19, wherein the module for construction of a three-dimensional anthropological model of the user is adapted to take into consideration a distance between preselected reference points on the external surface of the user body shape.
